(19) United States
(12) Patent Application Publication
(10) Pub. No.: US 2014/0019265 A1
(43) Pub. Date: Jan. 16, 2014

(54) Method of Commercializing Manufactured Products

(71) Applicant: Kenneth J. Susnjara, Birdseye, IN (US)

(72) Inventor: Kenneth J. Susnjara, Birdseye, IN (US)

(21) Appl. No.: 13/549,966

(22) Filed: Jul. 16, 2012

(51) Int. Cl. G06Q 30/02

(52) U.S. Cl. 705/14.73; 705/14.4

(57) ABSTRACT

A method of commercializing products including advertising the sale of such products to the public by a principal party; consummating the sale of such products with interested purchasers by the principal party; communicating with a fabricator, requesting the production and delivery of a product sold responsive to such advertising and providing required specifications of the sold product and certain aids useful in the fabrication of such product; and compensating such fabricator by such principal party for the fabrication of the sold product upon delivery of the product to the purchaser thereof.

### BACKGROUND OF THE INVENTION

In the production and sale of home and office furnishings, such products traditionally have been designed and manufactured in batches by a comparatively few number of entities, sold to geographically dispersed retailers and ultimately sold by such retailers to the public. Such general arrangement has a number of advantages. The centralized design and engineering of such products distributes the development costs of such products over a large number of products. The central manufacturing allows manufacturers of such products to locate in attractive labor costs areas, and employ high volume production equipment. Such arrangement, however, also has a number of overriding disadvantages. Only a limited number of designs can be offered at any time. All of such products usually are of a standard sign and size and are not adapted to customization in terms of design, dimensions, finishes and the like. Producers of such products have substantial warehousing, packaging, shipping and other carrying costs. Retailers similarly have substantial warehousing, showroom, personnel, marketing and carrying costs. In addition, when such products are removed from current offering, there are additional costs associated with unsold inventory.

Accordingly, it is the principal object of the present invention to provide an improved method of producing, marketing and selling manufactured products such as home and office furnishings, efficiently.

Another object of the present invention is to provide an improved method of producing, marketing and selling products which allows for a modification of the specifications of such products without incurring a significant cost penalty.

A further object of the present invention is to provide a method of producing, marketing and selling customized products in which warehousing, packaging and shipping costs are substantially reduced if not eliminated.

A still further object of the present invention is to provide a method of producing, marketing and selling manufactured products, allowing small fabricators to economically engage in the manufacture and sale of custom products without the requirement of designing and engineering such products.

Another object of the present invention is to provide for the commercialization of a line of products in which prospective purchasers can view, select, reconfigure and consummate the purchase of such products electronically over the internet.

A further object of the present invention is to provide an improved method of commercializing a line of products in small volume production rates at comparatively low material costs.

A more specific object of the invention is to provide an improved method of producing and selling custom furniture, closets, cabinets and other wood sheet based products for home and office.

### SUMMARY OF THE INVENTION

The objects of the present invention are achieved by the use of a method including the advertising for sale of a number of products to the public by a principal party; consummating the sale of such products with interested prospective purchasers by such principal party; communicating with a fabricator of a pre-established participating group of geographically dispersed fabricators having the capability of producing such products, requesting the production and delivery of a product sold in response to such advertising and providing required specifications of such sold product and certain aids useful in the fabrication of the sold product; and compensating such designated fabricators by the principal party for the production and delivery of such sold product upon delivery of such product by the fabricator to the purchaser thereof. Such advertising preferably would be conducted on a website on the internet and would include posting a listing of the products offered for sale, disclosing the specifications of such products, indicating the option of varying such specifications, listing a number of fabricators available for producing such products, instructing with respect to the purchasing procedure and identifying potential fabricators for the production and delivery of a purchased product. The consummation of the sale would include receiving an inquiry from an interested prospective purchaser of an advertised product, negotiating the specifications and price of a selected product, designating a listed fabricator for the production and delivery of the ordered product and effecting payment thereof, and processing the purchased order for the product, preferably electronically over the internet. The negotiating and processing further would include computing the sales price of the ordered product accounting for the charge of the designated fabricator and a service fee of the principal party, and subcontracting the production and delivery of the ordered product to the designated fabricator. The principal party further would devise and provide the designated fabricator an operating program for producing components of the sold product on a CNC machine. Preferably, such program would be transmitted electronically in encryptic format structured for one time usage.

### BRIEF DESCRIPTION OF THE DRAWING

FIG. 1 is a flow diagram of the method embodying the present invention.

### DETAILED DESCRIPTION OF THE PREFERRED EMBODIMENT OF THE INVENTION

As a perquisite to the practice by the present invention, a principal party would design a number of products to be offered for sale and develop a software program intended to be executed by the control systems of the CNC machines of the participating fabricators to produce components of each of the designed products which could be assembled to produce such products. Such party then would arrange for working arrangements with a number of preferably geographically dispersed fabricators having access to CNC machines and the capability of operating such machines with suitable software programs provided by the principal party to fabricate the components, and assemble them to produce such products. In establishing such arrangements, the principal party would acquire from such fabricators their various charges for producing and delivering the designated products, and request that such charges periodically be updated. Such charges would include the material and labor costs, the overhead expenses and the profit of the participating fabricators.

The principal party further would develop a website on the internet, advertising the designed products for sale, negotiating the sale of such products with responding interested prospective purchasers by identifying the products, determining the specifications of the products of interest, designating fabricators from the list of participating fabricators identified on the website and quoting sales prices, and consummating the sale of such products by submitting sales orders and tendering the sales prices therefor electronically.

In addition to the foregoing, the principal party would compute the sales prices of offered products upon receipt of inquiries, taking into account the fabricators designated by the purchasers and the charges of such fabricators for producing and delivering such products, and adding a service fee of the principal party. Such sales orders then would be forwarded to the designated fabricators with all pertinent information required to produce and deliver such products, along with the required operating programs for the designated fabricators which are functional to produce component parts of the purchased products. Such consummation of transactions would be transmitted electronically with the machine operating programs preferably being encrypted and designed for one time usage.

The purchased product may be fabricated in its entirety and delivered to the purchaser intact or the components thereof may be produced and delivered unassembled to the purchaser for assembly by the purchaser, as specified by the purchaser in the negotiations for the purchase of the product with the principal party.

Upon the production and delivery of the purchased product, the designated fabricator would notify the principal party and such party would remit to the fabricator the amount of the predetermined charge for the production and delivery of the particular product.

As a further accommodation to the participating fabricators, the principal party would negotiate arrangements with suppliers of raw materials required for the production of such products, for the supply of specified materials to designated fabricators for the production of sold products which would be optionally available to the participating fabricators. Orders for such raw materials would be placed upon referral of an order to a designated fabricator either on a standing basis or on an individual order basis. Such raw materials supply arrangement further would result in additional reduction in costs of the products.

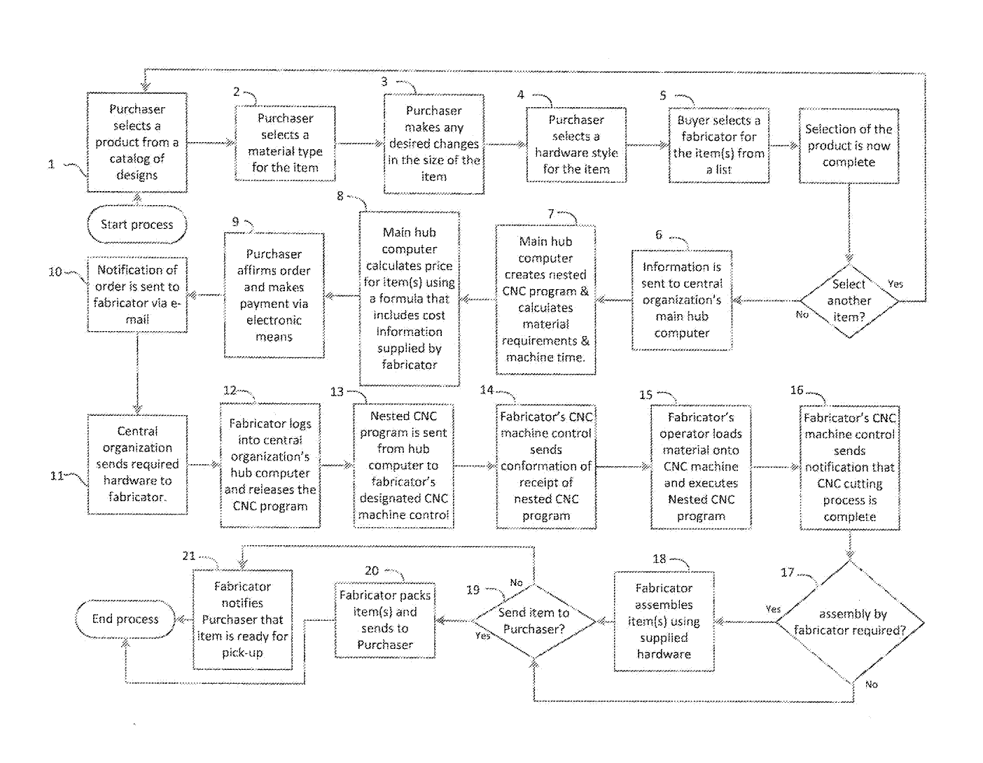

Referring to FIG. 1 of the drawing, there is provided a flow diagram indicating the procedure followed in practicing the present invention in the sale, production and delivery of a line of products such as household and office furnishings consisting of panels of wood, assembled, finished and provided with suitable hardware. In Steps Nos. 1 through 4, having logged onto and viewed the principal party's website, an interested prospective purchaser would select a product of interest from a list of products, designate the wood of which the product is to be produced, indicate any changes in the dimensions of the product and select the hardware to be applied. In Step No. 5, the purchaser would designate a fabricator for the production and delivery of the product, presumably one in the vicinity of the purchaser. Such selection process would be conducted electronically over the internet.

Upon receipt of such communication, in Steps Nos. 6 through 8, the principal party, in contemplation of the fabrication of the panels of the selected product on an CNC router by the designated fabricator, would create a CNC program for nesting the required panel components on one or more sheets of raw material for cutting such panels on a CNC router of the designated fabricator, calculate the raw material requirements for producing such panels through the use of such program and determine the machine time. It would then calculate the cost of the product to include materials, the charge of the designated fabricator and a service fee of the principal party, and then electronically transmit the sales price to the prospective purchaser. In Step No. 9, the prospective purchaser, upon acceptance the sales price, would submit an order for the quoted product and make payment electronically.

Upon receipt of a purchase order, in Steps Nos. 10 and 11, the principal party would notify the designated fabricator of the order and arrange for delivery of any raw material as may have been prearranged between such parties. In Steps Nos. 12 through 16, in response to receipt of the purchaser order, the fabricator would log onto the computer of the principal party for access to the CNC nesting program created by the principal party, the nested CNC program would be sent to the control system of the CNC router of the designated fabricator, receipt of such program would be acknowledged, personnel of the designated fabricator would load one or more sheets of raw material on the worktable of the CNC router and the machine would be operated to produce the component parts from such sheet or sheets of raw material.

Products offered in the program described can be ordered either assembled as a finished product or disassembled for assembly by the purchaser. In Step No. 17, a determination is made whether the product is be provided to the purchaser in assembled or disassembled form. If it is be assembled, in Step 18, the component panels are assembled, the assembled unit is finished as required and designated hardware is applied. In Step 19, it is determined whether the finished product is to be shipped to the purchaser and, if so, the designated fabricator packs and ships the finished product as in Step No. 20 and the process is completed. If it is determined that the finished product is to be picked up by the purchaser, such purchaser is notified of the availibility of the product, as in Step No. 21, and the process is completed upon such product being picked up by the purchaser. If the product is to be provided in disassembled form, in Step No. 19, it is determined whether the product components are to be shipped to the purchaser and, if so, the designated fabricator packs and ships the disassembled components and required hardware, as in Step No. 20, and the process is completed. If it is determined that the disassembled components of the product are to be picked up by the purchaser, such purchaser is notified of the availability of such component parts and related hardware, and the process is completed upon such components being picked up by the purchaser.

Upon shipment or delivery of the product in assembled or disassembled form, the designated fabricator so notifies the principal party which in response remits to the designated fabricator the predetermined charge for the production and delivery of the sold product or the components thereof.

As an added accommodation to the participating fabricators in the described program, the principal party would arrange for the central or individual purchase of raw materials such as lumber and hardware from one or more suppliers, and arrange for such raw materials to be delivered directly to specified fabricators, with the cost of such materials being taken into account by the principal party in the computation of the sales price submitted to the prospective purchaser and the remunerations of the charges of the respective designated fabricators. Such a provision could provide for lower costs to prospective purchasers and an accommodation to participating fabricators.

In the embodiment as described, interested prospective purchasers would have access to libraries of designed products from which to select and optionally customize. The site would include choices of material, finish, edging, size and hardware. The material selection would consist of a hardwood plywood formed of walnut, cherry, oak or maple. The finish may be painted, stained or left unfinished for completion by the purchaser. Examples of edge banding would be offered from which a selection may be made. If the size of the advertised product would not comply with the purchaser's requirements, the dimensions of the product could be adjusted. The hardware to be attached also may be selected and specified.

Upon receipt of such an inquiry and the specifications of an interested product, the principal party, sometimes referred to as the hub organization, modifies the software providing the nesting and cutting pattern of wooden raw material sheets used to form the constituent parts of the designated product, assuming dimensional changes have been specified, and computes the selling price of the designated part taking into account the cost of the wood and hardware, if to be supplied by the principal party, the cost of the designated fabrication as previously indicated by the designated fabricator and a fee of the principal party. Upon submission of the computed sales price to the prospective purchaser, receipt of a purchaser order and payment, the principal party would notify the designated fabricator of the sale and arrange for shipment of any prearranged provision for the supply of wooden sheet materials, edge banding materials and appropriate hardware including fittings, screws, rails, pulls, knobs and the like.

Prior to launching such a program, the network of fabricators would have to be selected, qualified and indocrinated in the operation of the program. Such fabricators usually would consist of cabinet makers, woodworking shops and the like having access to a CNC router with a controller suitably programmed to communicate with the principal party to receive the cutting pattern software over the internet, edge banders and the other normal tooling. Upon receipt of notice of a sale and any materials arranged to be provided by the principal party, a designated fabricator would then access the computer of the principal party to obtain the program to produce the required parts on the router. Nothing would prevent any member of such a network to advertise locally to end users and retail establishments of the availability of such products, presumably in cooperation with the principal party.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

I claim:

1. A method of commercializing products, comprising:
advertising the sale of said products to the public by a principal party;
consummating the sale of said products with interested prospective purchasers by said principal party;
communicating with a fabricator of a pre-established group of geographically dispersed fabricators having the capability of producing said products, by said principal party, requesting the production and delivery of a product sold in response to said advertising and providing required specifications of said sold product and certain aids useful in the fabrication of said sold product; and
compensating said fabricator by said principal party for the fabrication and delivery of said sold product upon delivery of said product to the purchaser thereof.

2. The method of claim 1 wherein said advertising includes posting a listing of the products offered for sale, disclosing the specifications of said products, indicating the option of varying said specifications, listing a number of fabricators available for producing said products, instructing with respect to the purchasing procedure and identifying potential fabricators for the production and delivery of a purchased product.

3. The method of claim 2 wherein said advertising is conducted on a website on the internet.

4. The method of claim 1 wherein said consummating a sale includes receiving an inquiry from an interested prospective purchaser of an advertised product, negotiating the specification and price of a selected product, designating a listed fabricator for the production and delivery of the ordered product and effecting payment thereof, and processing the purchase order thereof.

5. The method of claim 4 wherein said consummating of a sale is conducted electronically over the internet.

6. The method of claim 4 wherein said negotiating and processing includes computing the sales price of the ordered product accounting for the charge of the designated fabricator and a service fee of said principal party, and subcontracting the production and delivery of said ordered product to said designated fabricator.

7. The method of claim 4 including devising and providing said designated fabricator an operating program for producing components of the sold product on a CNC machine.

8. The method of claim 4 including transmitting said operating program in encrypted format structured for one time usage.

9. The method of claim 6 including periodically updating the charges of said fabricators for use in quoting sales prices for said products.

10. The method of claim 6 wherein said charge of said designated fabricator includes the material and labor costs, the operating expenses and the profit of said fabricator pertinent to the fabrication and delivery of an ordered product.

11. The method of claim 1 including optionally offering and providing said products in assembled or unassembled condition.

12. The method of claim 1 including providing by said principal party for the supply of raw materials to said fabricators.

13. A method of commercializing products formed of certain panels cut from sheets of material, comprising:
advertising the sale of said products to the public by a principal party;
consummating the sale of said products with interested prospective purchasers by said principal party;
communicating with a fabricator of a pre-established group of geographically dispersed fabricators having the capability of producing said products, by said principal party, requesting the production and delivery of a product sold in response to said advertising, and providing required specifications of said sold product and certain aids useful in the fabrication of said sold product; and
compensating said fabricator by said principal party for the fabrication and delivery of said sold product upon delivery of said product to the purchaser.

14. The method of claim 13 wherein said advertising includes posting a listing of the products offered for sale, disclosing the specifications of said products, indicating the option of varying said specifications, listing a number of fabricators committed to producing and delivering said products, instructing with respect to the purchasing procedure and designating one of said fabricators for the production and delivery of a purchased product.

15. The method of claim 14 wherein said advertising is conducted on a website on the internet.

16. The method of claim 13 wherein said consummating a sale includes receiving an inquiry from an interested prospective purchaser of an advertised product, negotiating the specification and price of a selected component and effecting payment thereof, and processing the purchase order thereof.

17. The method of claim 16 wherein said consummating of a sale of a product is conducted electronically over the internet.

18. The method of claim 16 wherein said negotiating and processing includes computing the sales price of the ordered product, accounting for the charge of the designated fabricator and a service fee of said principal party, and subcontracting the production and delivery of said ordered product to said designated fabricator.

19. The method of claim 18 including devising and providing said designated fabricator, an operating program for a CNC machine for producing said panels of said sold product.

20. The method of claim 19 wherein said CNC machine comprises a CNC router.

21. The method of claim 16 including transmitting said operating program in encryptic format structured for one time usage.

22. The method of claim 18 including periodically updating the charges of said fabricators for use in quoting sales prices for said products.

23. The method of claim 18 wherein said charge of said designated fabricator includes the material and labor costs, the operating expenses and the profit of said fabricator pertinent to the fabrication and delivery of an ordered product.

24. The method of claim 13 including optionally offering and providing said products in assembled or unassembled form.

25. The method of claim 13 including arranging by said principal party for the supply of raw materials to said fabricators.
